(19) United States
(12) Patent Application Publication
(10) Pub. No.: US 2019/0309834 A1
(43) Pub. Date: Oct. 10, 2019

(54) ROTATIONAL TO RADIAL MOTION TRANSLATION DEVICE

(71) Applicant: DAVID E. MURRAY, MILTON, MA (US)

(72) Inventor: DAVID E. MURRAY, MILTON, MA (US)

(21) Appl. No.: 15/946,668

(22) Filed: Apr. 5, 2018

(51) Int. Cl. F16H 21/18

(52) U.S. Cl. CPC F16H 21/18

(57) ABSTRACT

The rotational to radial motion translation device is a variation of a device known as an overbalanced wheel. The device includes a hub with a number of spokes extending therefrom. Each spoke includes a movable slider assembly mounted thereon. A circular track engages a wheel on each slider assembly, such that as the hub rotates, the slider assemblies are move outward and inward on the spokes, providing a rotational to radial motion translation. The device can be used as a demonstration device, for example, for orbital mechanics, as a modified flywheel, or as an exercise device.

### BACKGROUND

### 1. Field

The disclosure of the present patent application relates to motion translation or transmission devices, and particularly to a rotational to radial motion translation device.

### 2. Description of the Related Art

Motion translation or transmission devices for converting a first motion to a second different type of motion are known in the art. For example, worm drives convert rotary motion into linear motion. Piston type devices convert linear motion to rotary motion. Many amusement devices, such as amusement rides, combine rotary, swinging, and linear motion to provide visually and physically entertaining sensations. While a limited number of rotary to radial translation devices are known, these devices use complicated curved load guides, which are unable to provide smooth movement and are likely to cause binding of the mechanism.

Thus, a rotational to radial motion translation device solving the aforementioned problems is desired.

### SUMMARY

In a first embodiment, the rotational to radial motion translation device includes a base, at least one circular guide track mounted on top of the base, a hub rotatably mounted on an axle, the axle extending through a plate mounted on the at least one circular guide track, at least one spoke extending radially from the hub, at least one slider assembly mounted on the at least one spoke, the slider assembly being configured to slide along the length of the spoke, and track engagement means mounted on the at least one slider assembly for engaging the at least one circular guide track, such that as the hub rotates, the at least one slider assembly is urged to travel in a radial direction along the at least one spoke.

In a second embodiment, the rotational to radial motion translation device includes a base, a plurality of circular guide tracks mounted on top of the base, a plurality of hubs each hub being rotatably mounted on an axle, the axle extending through a plurality of plates, each plate being mounted on one of the plurality circular guide tracks, a plurality of spokes, at least one spoke of the plurality of spokes extending radially from one of the hubs, a plurality of slider assemblies, each slider assembly being mounted on one of the plurality of spokes, the slider assemblies being configured to slide along the length of their associated spoke, and track engagement means mounted on the plurality of slider assemblies for engaging one of the plurality of circular guide tracks, such that as the hub rotates, the slider assemblies are urged to travel in a radial direction along their associated spoke.

These and other features of the present disclosure will become readily apparent upon further review of the following specification and drawings.

### BRIEF DESCRIPTION OF THE DRAWINGS

FIG. 1 is an environmental, perspective view of a rotational to radial motion translation device.

FIG. 2 is a front view of the rotational to radial translation device of FIG. 1, shown with the front of the base and the front circular guide track removed to show details thereof.

FIG. 3 is a side view of a first rotational to radial motion translation device of FIG. 1, shown with a second device (in phantom) connected in cascade to the first device.

FIG. 4 is a partial view of a single spoke of the rotational to radial motion translation device of FIG. 1, showing details of a slider assembly mounted thereon.

FIG. 5 is a section view drawn along lines 5-5 of FIG. 4.

Similar reference characters denote corresponding features consistently throughout the attached drawings.

### DETAILED DESCRIPTION OF THE PREFERRED EMBODIMENTS

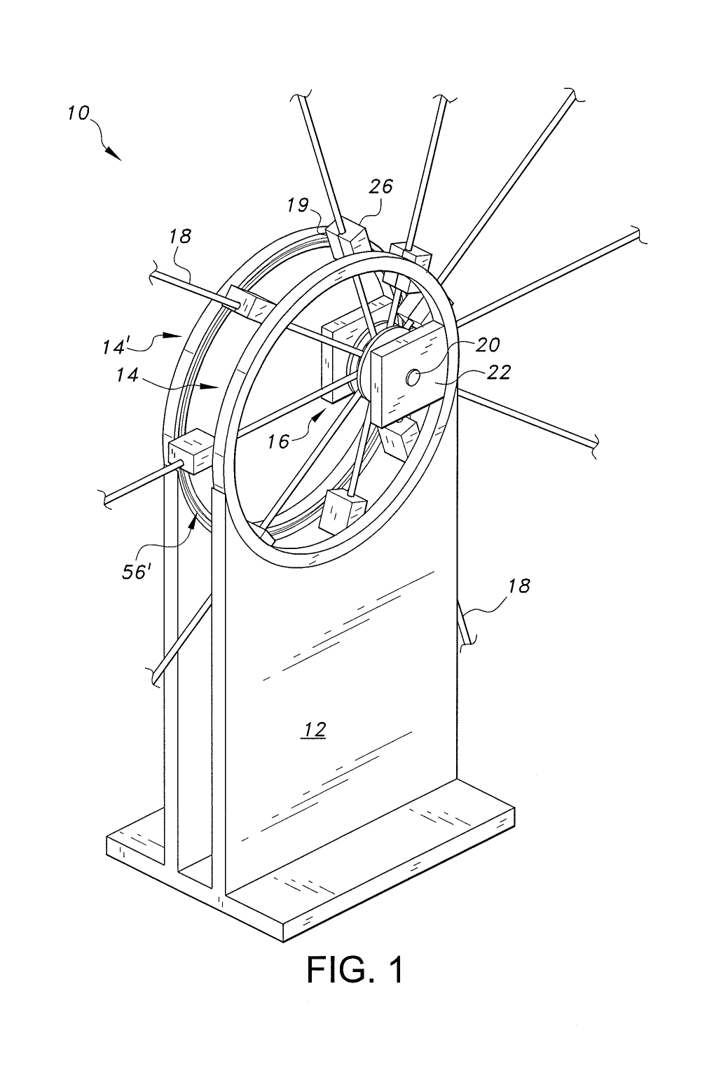

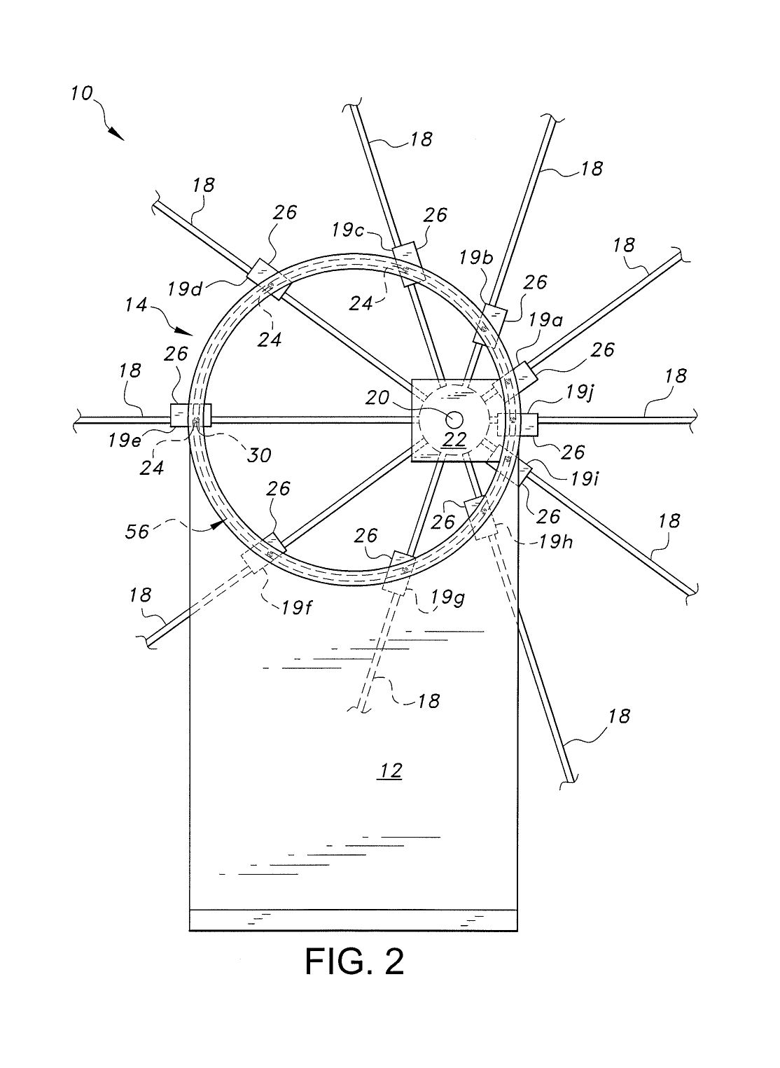

A rotational to radial motion translation device is shown in FIGS. 1-3. The rotational to radial motion translation device 10 includes a base or stand 12 for supporting two parallel circular guide tracks 14. A hub 16 is rigidly mounted on an axle 20, which extends through plates 22, 22′ mounted on an inner edge of the front and rear circular guide tracks 14, respectively, so that the axle 20 is eccentrically mounted between the two circular tracks 14. A bearing (not shown) allows the axle 20 to rotate relative to the plates 22, 22′, the hub 16 and the spokes 18 joined thereto being constrained to rotate with the axle 20. As shown in FIG. 2, a plurality of spokes 18 extend radially from the hub 16, each spoke 18 having a slider assembly 19a through 19h, respectively, mounted thereon (the slider assemblies are generically identified as 19 in FIGS. 1, 3, 4, and 5). The slider assemblies 19a -19h are configured to slide along the length of their associated spoke 18. The spokes 18 extend radially from the hub 16 and are spaced equidistant or equiangular from each other. Track engagement means (described in detail below) are mounted on each of the slider assemblies 19 for engaging the circular guide tracks 14, such that as the hub 16 rotates, the slider assemblies 19 are urged to travel in a radial direction along the spokes 18. The circular shape of the guide tracks 14 provides a smooth, relatively slow transition of the slider assemblies 19 as the hub 16 rotates. A weight 26 may be attached to the slider assemblies 19 to provide greater inertial momentum to the system, for even smoother operation, similar to a flywheel.

It should be noted that while ten spokes 18 are shown attached to the hub 16, any number of spokes 18 can be mounted to the hub 16, from as few as one to as many as can fit on the hub 16, considering the size and space limitations. It should further be noted that while two circular guide tracks 14 are shown in FIG. 1, a single track may be used to allow viewing of the internal components of the device 10. This is particularly useful when the device 10 is used for demonstration purposes.

The operation of the device 10 is best described with respect to FIG. 2. The slider assembly 19j is shown to the right of the hub 16, at the closest location to the hub 16 and relatively horizontal (at angle 0° relative to the center of the circular track 14). As the hub 16 rotates counterclockwise, the slider assembly 19 assumes the position shown at by slider assembly 19a, where it has moved further outward on the spoke 18, and is tilted upward and to the right at approximately 45° to horizontal. When the axle 20 rotates so that the slider assembly 19 has moved yet further outward on the spoke 18 to the position occupied by slider assembly 19c in FIG. 2 and is tilted to the left of vertical. When the axle 20 has rotated so that the slider assembly has the position occupied by slider assembly 19d in FIG. 2, the slider assembly has moved yet further outward on the spoke 18 and is tilted upward and to the left at approximately 135° relative to the center of the circular track 14. When the axle 20 has rotated so that the slider assembly occupies the position of slider assembly 19e in FIG. 2, the slider assembly is in its farthest location from the hub 16 and is relatively horizontal (at angle 180° relative to the center of the circular track 14). When the axle 20 has rotated so that the slider assembly occupies the position of slider assembly 19f in FIG. 2, the slider assembly has moved inward on spoke 18 and is tilted downward and to the left (at angle 225° relative to the center of the circular track 14). When the axle 20 has rotated so that the slider assembly occupies the position of slider assembly 19g in FIG. 2, the slider assembly has moved yet further inward on the spoke 18 and is tilted slightly left of vertical. Finally, when the axle 20 has rotated so that the slider assembly occupies the position of slider assembly 19h in FIG. 2, the slider assembly has moved yet further inward on the spoke 18 and is tilted downward and to the right (at angle 315° relative to the center of the circular track 14). As the hub 16 rotates further, the process is repeated. It should be noted that the changing orientation of the slider assemblies 19 would be useful for application as a water wheel, wherein on one side of the device 10 water would be maintained in a chamber (not shown) on one surface of the slider assemblies, while on the other side of the device 10, the water would be emptied from the chamber.

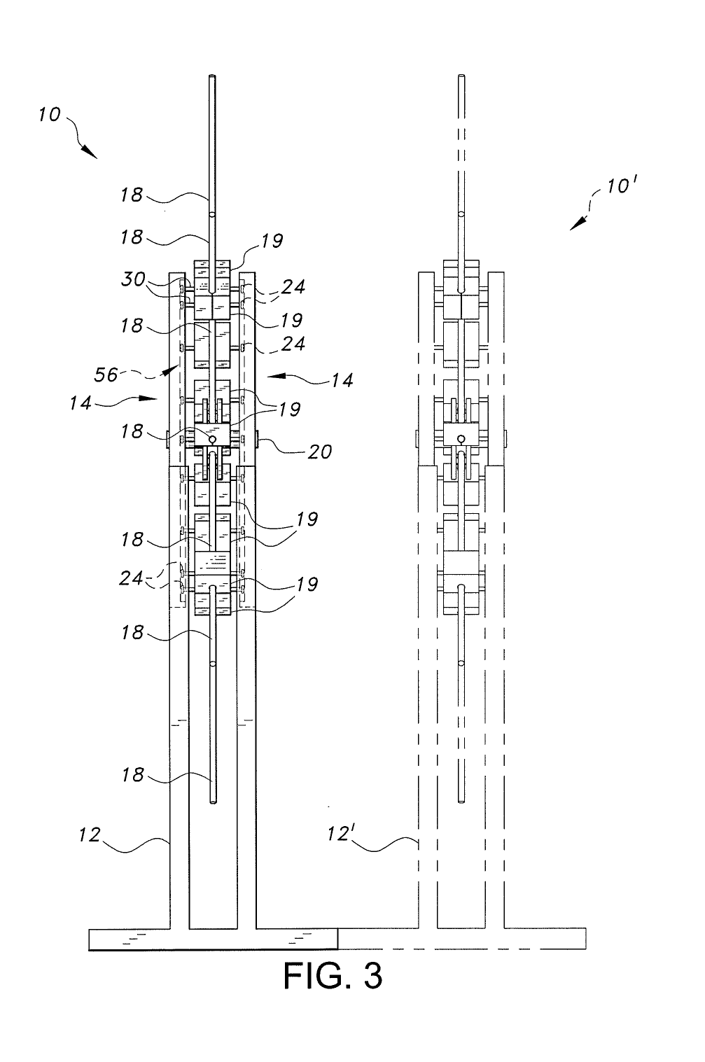

As shown in FIG. 3 in dotted lines, multiple units 10, 10′ can be mounted on a single base (or separate bases 12, 12′ joined together) and use a common axle 20, such that all hubs 16 rotate in unison. As many units 10, 10′ as desired can be joined in such a manner. The tracks 14 can be used by adjacent units to reduce the number of tracks required. This is explained further below.

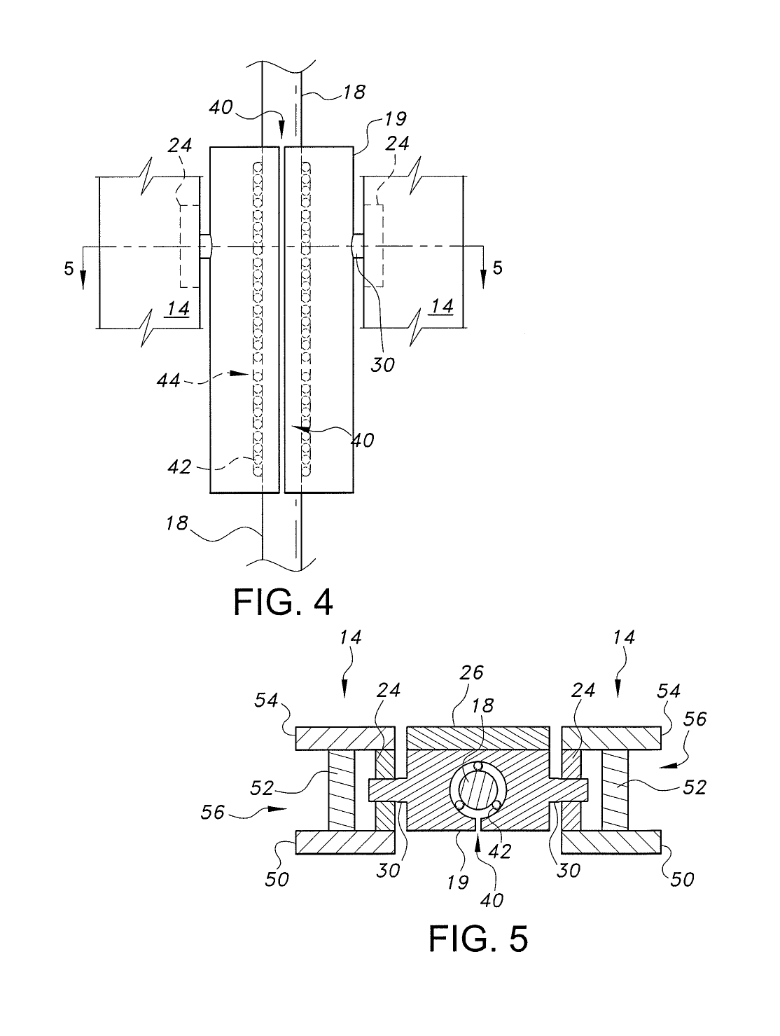

The details of the slider assemblies 14 are best seen in FIGS. 4-5. The track engagement means include pins 30 extending from the sides of the slider assembly 19 and wheels 24 rotatably mounted on the pins 30 for engaging the circular guide tracks 14. While two sets of pins, wheels and tracks are shown, only one is necessary, as described above. The slider assembly 19 further includes three linear bearing races 42 with ball bearings 44 on its interior surface to reduce friction between the slider assembly 19 and the spoke 18. An open slot 40 provides access to the interior of the slider assembly 19 for inspection or lubrication of the bearing races 42 and ball bearings 44.

The circular guide track 14 includes a first track portion 50, a second track portion 50′ and an elastomeric member 52 connecting the two track portions 50, 50′ together. The wheels 24 are located between the two track portions 50 and 50′, which constrain the sliding assemblies 19 to rotate between the front and rear circular guide tracks 14 while sliding up and down on the spokes 18. It should be noted that the space between the track portions 50, 50′ could be occupied by another wheel 24 when multiple units are used, as described above.

It is to be understood that the rotational to radial motion translation device is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

I claim:

1. A rotational to radial motion translation device, comprising:
a base;
at least one circular guide track mounted on top of the base;
an axle eccentrically and rotationally mounted inside the at least one circular guide track;
a hub rigidly mounted on the axle for rotation therewith;
at least one spoke extending radially from the hub, the spoke being constrained to rotate with the hub;
at least one slider assembly slidably mounted on the at least one spoke; and
means mounted on the at least one slider assembly for engaging the at least one circular guide track, such that as the hub rotates, the at least one slider assembly is constrained to follow the circular guide track while sliding in a radial direction along the at least one spoke.

2. The rotational to radial motion translation device according to claim 1, further comprising at least one weight mounted on the at least one slider assembly.

3. The rotational to radial motion translation device according to claim 1, wherein the slider assembly has an interior surface bearing against the at least one spoke, the device further comprising at least three linear bearing races mounted on the interior surface to reduce friction between the at least one slider assembly and the at least one spoke.

4. The rotational to radial motion translation device according to claim 3, further comprising a plurality of ball bearings disposed within the at least three linear bearing races.

5. The rotational to radial motion translation device according to claim 1, wherein the means for engaging comprises at least one pin extending laterally from the at least one slider assembly and at least one wheel rotatably mounted on the at least one pin and engaging the at least one circular guide track.

6. The rotational to radial motion translation device according to claim 5, wherein:
the at least one circular guide track comprises two parallel circular guide tracks;
the at least one pin comprises two pins, the pins extending from opposite sides of the at least one slider assembly, respectively; and
the at least one wheel comprises two wheels, the wheels being mounted on a corresponding one of the two pins and engaging one of the two circular guide tracks, respectively.

7. The rotational to radial motion translation device according to claim 5, wherein the at least one circular guide track includes a first track portion, a second track portion and an elastomeric member connecting the first and second track portions in spaced relation, the at least one wheel being disposed between the first and second track portions.

8. The rotational to radial motion translation device according to claim 1, wherein the at least one slider assembly includes an open slot defined therein for access to an interior of the at least one slider assembly.

9. The rotational to radial motion translation device according to claim 1, wherein the at least one spoke comprises a plurality of spokes and at least one slider assembly comprises a plurality of slider assemblies, each of the slider assemblies being mounted on a corresponding one of the plurality of spokes.

10. The rotational to radial motion translation device according to claim 9, wherein the plurality of spokes extend radially from the hub and are spaced equiangular from each other.
